(19) United States
(12) Patent Application Publication
(10) Pub. No.: US 2022/0226089 A1
(43) Pub. Date: Jul. 21, 2022

(54) DENTAL APPARATUS FOR DETERMINATION AND PROCESSING OF ROOT CANAL WORKING LENGTH AND DENTAL SYSTEM USING SAME

(71) Applicants: VATECH Co., Ltd., Gyeonggi-do (KR); VATECH EWOO Holdings Co., Ltd., Gyeonggi-do (KR)

(72) Inventors: Jin Kook ROH, Gyeonggi-do (KR); Suk Bae SONG, Gyeonggi-do (KR); Hyun Rak CHOI, Gyeonggi-do (KR); Un Seok HAM, Gyeonggi-do (KR)

(73) Assignees: VATECH Co., Ltd., Gyeonggi-do (KR); VATECH EWOO Holdings Co., Ltd., Gyeonggi-do (KR)

(21) Appl. No.: 17/577,160

(22) Filed: Jan. 17, 2022

(30) Foreign Application Priority Data
Jan. 15, 2021 (KR) 10-2021-0005803
Jan. 15, 2021 (KR) 10-2021-0005804

(51) Int. Cl. A61C 19/04; A61C 5/42

(52) U.S. Cl. CPC A61C 19/041; A61C 5/42

(57) ABSTRACT

Provided are a dental apparatus and a dental system using the dental apparatus, the dental apparatus including a signal detector configured to detect an electrical signal varying according to a distance between a file inserted into a tooth and an apical foramen, and a controller configured to execute a first mode for calculating the distance between the apical foramen and the file by using the electrical signal and for displaying the distance on a screen, and configured to execute a second mode for displaying root canal working length information and identification information received through a communication part or input part, on the screen, for generating identified root canal working length information by using the root canal working length information and the identification information, and for transmitting the identified root canal working length information to the external device through the communication part according to the input signal.

### CROSS REFERENCE TO RELATED APPLICATION

The present application claims priority to Korean Patent Application No. 10-2021-0005803 (filed on Jan. 15, 2021), and 10-2021-0005804 (filed on Jan. 15, 2021), the entire contents of which is incorporated herein for all purposes by this reference.

### BACKGROUND OF THE INVENTION

### Field of the Invention

The present disclosure relates to a dental apparatus used for root canal treatment, and a dental system using the dental apparatus. More particularly, the present disclosure relates to a dental apparatus for determination of a root canal working length that is a working length of root canal treatment and for processing of the determined root canal working length, and a dental system using the dental apparatus.

### Description of the Related Art

Root canal treatment, commonly called endodontic treatment, is provided in the following order: pulp chamber opening, pulp extirpation, determination of a root canal working length, canal preparation, and canal filling.

Pulp chamber opening is a process of determining the location and the shape of a pulp chamber corresponding to the coronal part of a root canal, which is an anatomic space inside a tooth where the pulp exists, and of forming a hole in the tooth to enter the pulp chamber.

Pulp extirpation is a process of removing the pulp inside the tooth through the pulp chamber. The pulp is a soft tissue rich in nerves and blood vessels within the root canal, and is connected to the alveolar bone tissue outside the tooth through the apical foramen at the tip of the root canal.

Determination of a root canal working length is a process of determining a root canal working length that is the working length of root canal treatment. The root canal working length corresponds to the distance from the cusp tip of the tooth to the apical foramen at the tip of the root canal, more specifically, to the apical constriction that is at the more inner side than the apical foramen.

Canal preparation is a process of increasing the volume of the root canal to facilitate the use of a tool, cleaning, and filling in the following processes. Pulp canal filling is a process of filling the root canal with a substitute material for the pulp and sealing the entrance.

In the root canal treatment, if the determined root canal working length is shorter than the actual working length, bacteria in the remaining part cannot be removed. If the determined root canal working length is longer than the actual working length, there is a high possibility of endodontic perforation in the following processes.

Therefore, determining the root canal working length accurately is an important factor in determining success or failure of root canal treatment.

To determine a root canal working length, a file in the shape of a thin and long pin is used. A user makes the file penetrate a stopper made of a soft material, such as rubber, and inserts the file to the point close to the apical foramen through the hole formed in the tooth during the pulp chamber opening. In this process, only the file is inserted into the tooth while the stopper is caught on the cusp tip of the tooth. Next, the user extracts the file from the tooth, actually measures the distance from the stopper to the end of the file with a dedicated ruler called an endo ruler to calculate the root canal working length corresponding to an in-tooth insertion length of the file, and records the obtained root canal working length in an electronic medical record of a subject for reference in the following processes.

In the determination of the root canal working length, if the file is excessively inserted into the tooth, there is a risk of endodontic perforation. Therefore, in determining the root canal working length, a particular device, an apex locator, is used.

A general apex locator calculates a distance between a file and an apical foramen by using a unique electrical resistance value that the apical foramen has. The user connects the file to the apex locator, inserts the file into the tooth until the distance between the apical foramen and the file end displayed by the apex locator reaches a preset reference value, and extracts the file.

Korean Patent No. 10-1712574 discloses a root canal working length determination technology using an apex locator and a dedicated ruler.

For general root canal working length determination, the user uses an apex locator and an endo ruler, but they are separate. Therefore, the root canal working length measured with the endo ruler must be input manually by the user to the electronic medical record. This is inconvenient, and if there is a mistake in matching the tooth with the root canal working length or in recording the root canal working length in the manual input process, serious results such as endodontic perforation may occur.

The foregoing is intended merely to aid in the understanding of the background of the present disclosure, and is not intended to mean that the present disclosure falls within the purview of the related art that is already known to those skilled in the art.

### Document of Related Art

(Patent Document 1) Korean Patent No. 10-1712574.

### SUMMARY OF THE INVENTION

The present disclosure is directed to providing a dental apparatus capable of determination of a root canal working length as well as processing of the determined root canal working length, and a dental system using the dental apparatus.

According to the present disclosure, there is provided a dental apparatus for determination and processing of a root canal working length that is a working distance for root canal treatment, the dental apparatus including: a signal detector configured to detect an electrical signal varying according to a distance between a file inserted into a tooth and an apical foramen; a display configured to provide a screen; a communication part configured to communicate with an external device; an input part configured to receive an input signal caused by user manipulation; a controller configured to execute a first mode for calculating the distance between the apical foramen and the file by using the electrical signal and for displaying the distance on the screen, and configured to execute a second mode for displaying root canal working length information and identification information received through the communication part or the input part, on the screen, for generating identified root canal working length information by using the root canal working length information and the identification information, and for transmitting the identified root canal working length information to the external device through the communication part according to the input signal; and a storage configured to store therein the root canal working length information, the identification information, and the identified root canal working length information.

A plurality of the external devices may include a first and a second device, the root canal working length information may be received from the first device through the communication part, the identification information may be received from the second device through the communication part, and the identified root canal working length information may be transmitted to the second device through the communication part.

In addition, the first device may be a file length measurement device configured to measure an in-tooth insertion length of the file and transmit the in-tooth insertion length of the file to the communication part as the root canal working length information, and the second device may be a server configured to store therein an electronic medical record including the identification information.

In addition, the identification information may include at least one selected from a group of subject identification information, tooth identification information, and root canal working length identification information.

In addition, the signal detector may include: a holder configured to have the file connected thereto; and a probe configured to be connected to a subject's lip, and the signal detector may be configured to detect a change in an impedance or resistance value varying according to the distance between the apical foramen and the file.

In addition, the controller may be configured to display a warning message on the screen when the distance between the file and the apical foramen is equal to or lower than a preset reference value in the first mode.

In addition, the dental apparatus may further include a speaker configured to generate a warning sound, wherein the controller may be configured to emit the warning sound through the speaker when the distance between the file and the apical foramen is equal to or lower than a preset reference value.

In addition, the controller may be configured to display the root canal working length information and the identification information on the screen by using the identified root canal working length information received from the external device to the communication part in the second mode.

In addition, according to the present disclosure, there is provided a dental system using the dental apparatus, the dental system including: the dental apparatus; a file length measurement device configured to measure an in-tooth insertion length of the file and transmit a measurement value of the in-tooth insertion length to the communication part as the root canal working length information; and a server configured to receive the identified root canal working length information from the communication part and store therein the identified root canal working length information.

The server may be configured to transmit the identified root canal working length information pre-stored therein, to the communication part, and the controller may be configured to display the root canal working length information and the identification information on the screen by using the identified root canal working length information received from the server to the communication part in the second mode.

The dental apparatus according to the present disclosure calculates and displays the distance between the file inserted into the tooth and the apical foramen to determine the root canal working length. In addition, the dental apparatus according to the present disclosure generates the identified root canal working length information by using the root canal working length information and the identification information that are received from the outside or input, and stores or transmits the identified root canal working length information to the outside. The dental apparatus displays the root canal working length information and the identification information to the user by using the identified root canal working length information transmitted from the outside.

The dental system according to the present disclosure integrates the root canal working length information with the identification information as the identified root canal working length information, and stores and processes the identified root canal working length information, so that errors in matching the tooth with the root canal working length or in recording the root canal working length can be reduced, and the root canal working length information and the identification information can be recognized and utilized anytime with the identified root canal working length information.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view of a dental system according to the present disclosure;

FIG. 2 is a view of an interface screen displayed on a first display of a dental apparatus according to the present disclosure;

FIG. 3 is a front view of a file length measurement device according to the present disclosure;

FIG. 4 is a rear perspective view of a file length measurement device according to the present disclosure;

FIG. 5 is a rear perspective view of a part of a body of a file length measurement device according to the present disclosure;

FIG. 6 is a front perspective view of a file support of a file length measurement device according to the present disclosure; and

FIG. 7 is a view of a length measurement part of a file length measurement device according to the present disclosure.

### DETAILED DESCRIPTION OF THE INVENTION

Hereinbelow, exemplary embodiments of the present disclosure will be described in detail with reference to the accompanying drawings such that the present disclosure can be easily embodied by those skilled in the art to which this present disclosure belongs. However, the present disclosure may be embodied in various different forms and should not be limited to the embodiments set forth herein. Further, in order to clearly explain the present disclosure, portions that are not related to the present disclosure are omitted in the drawings, and like reference numerals designate like elements throughout the specification. In the specification, a redundant description of the same element will be omitted. In addition, in the specification, it will be understood that when an element is referred to as being “coupled” or “connected” to another element, it can be directly coupled or connected to the other element or intervening elements may be present therebetween. In contrast, in the specification, it should be understood that when an element is referred to as being “directly coupled” or “directly connected” to another element, there are no intervening elements present. In addition, the terms used in the specification merely used to described particular embodiments, and are not intended to limit the present disclosure. In addition, in the specification, an expression used in the singular encompasses the expression of the plural, unless it has a clearly different meaning in the context. In addition, in the specification, it is to be understood that terms such as “including”, “having”, etc. are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added. In addition, in the specification, the term “and/or” includes a combination of a plurality of items or any one of a plurality of terms. In the specification, the expression “A or B” may include “A”, “B”, or “both A and B”. In addition, in the specification, if it is decided that the detailed description of known function or configuration makes the subject matter of the present disclosure unclear, the detailed description is omitted.

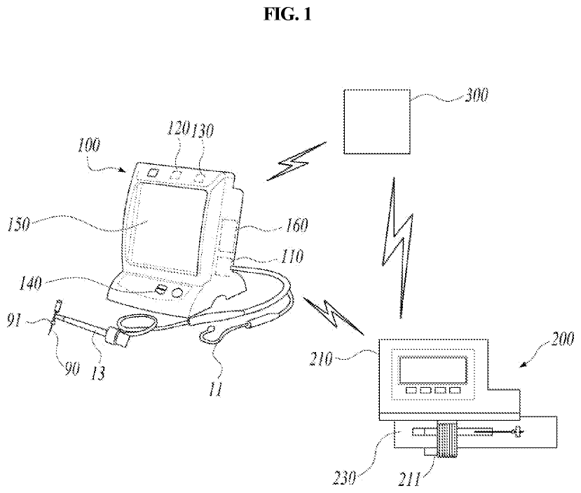

FIG. 1 is a view of a dental system according to the present disclosure.

The dental system includes a dental apparatus (herein, referred to as a dental apparatus) 100 for determination and processing of a root canal working length, a file length measurement device 200, and a server 300.

The dental apparatus 100 performs switching between a first mode for determining the root canal working length and a second mode for processing the determined root canal working length, according to a user's selection. In the first mode, the dental apparatus 100 calculates a distance between a file 90 inserted into a tooth and the apical foramen and displays the distance to the user. In the second mode, the dental apparatus 100 receives root canal working length information transmitted from the file length measurement device 200 that is a first external device or input by the user, and receives identification information transmitted from the server 300 that is a second external device or input by the user. The dental apparatus 100 generates identified root canal working length information by using the root canal working length information and the identification information. According to the user's selection, the dental apparatus 100 stores the identified root canal working length information or transmits the same to the server 300 that is the second external device. In addition, in the second mode, the dental apparatus displays the root canal information and the identification information to the user using the identified root canal working length information transmitted from the server 300 that is the second external device or stored in the dental apparatus.

The file length measurement device 200 actually measures an in-tooth insertion length of the file 90, and transmits the measured in-tooth insertion length of the file 90 as the root canal working length information to the dental apparatus 100 according to the user's selection.

The server 300 transmits the identification information to the dental apparatus 100 according to the user's selection, receives and stores therein the identified root canal working length information transmitted from the dental apparatus, and transmits the pre-stored identified root canal working length information to the dental apparatus 100. The server 300 may include a computer system inside and outside a dental clinic, and a database in cooperation with the computer system. The server 300 may include a patient management system (PMS) for storing therein, sharing, and managing a subject's electronic medical record. The electronic medical record stores various pieces of electronic medical information according to the identification information. The server 300 transmits the identification information included in the electronic medical record to the dental apparatus 100 according to the user's selection, stores the identified root canal working length information received from the dental apparatus 100 in the electronic medical record according to the identification information, and transmits the identified root canal working length information stored in the electronic medical record to the dental apparatus 100.

Each element will be described in detail.

The dental apparatus 100 includes a signal detector 110, a storage 120, a first communication part 130, a first input part 140, a first display 150, and a first controller 160.

The signal detector 110 is for the first mode. The signal detector 110 includes a probe 11 and a holder 13. The probe 11 is connected to the signal detector 110 by a cable and is connected to the subject's lip. The holder 13 is connected to the signal detector 110 by a cable. The file 90 is detachably connected to the holder 13. In the first mode, the signal detector 110 applies a predetermined electrical signal to the file 90 through the holder 13, and detects an electrical signal, such as a resistance value or an impedance value, varying according to the distance between the apical foramen and the file, through the probe 11.

The storage 120 stores therein various pieces of information used or generated by the dental apparatus 100. The storage 120 stores therein the root canal working length information transmitted from the file length measurement device 200 or input by the user, the identification information transmitted from the server 300 or input by the user, and the identified root canal working length information generated by the first controller 130. The storage 120 also stores therein various types of software/firmware and/or various pieces of information for the operation of the dental apparatus 100. For example, the storage 120 may be realized as any one storage medium of the following: a flash memory, a hard disk, the MultiMedia Card (MMC), a card type memory (for example, a Secure Digital (SD) card or an eXtream Digital (XD) card), random-access memory (RAM), static random-access memory (SRAM), read-only memory (ROM), electrically erasable programmable read-only memory (EEPROM), a programmable read-only memory (PROM), a magnetic memory, a magnetic disk, and an optical disk.

The first communication part 130 communicates with first and second external devices over a wired/wireless communication network. The first communication part 130 receives the root canal working length information from the file length measurement device 200 that is the first device, receives the identification information from the server 300 that is the second device, transmits the identified root canal working length information to the server 300 that is the second device, and receives the identified root canal working length information from the server 300 that is the second device. For example, the first communication part 130 may be configured to realize a communication protocol that supports transmission and reception of various pieces of information. In this case, the communication protocol may be realized with appropriate hardware and/or firmware. In some embodiments, examples of the communication protocol may include Transmission Control Protocol/Internet Protocol (TCP/IP) and/or User Datagram Protocol (UDP). The first communication part 130 may be realized as hardware and/or firmware for realizing various Radio Access Technologies (RATs) including LTE/LTE-A. In some embodiments, the first communication part 130 may be realized to conform to a wireless communication interface standard such as LTE-UE. In some embodiments, the first communication part 130 may realize RATs adopted in a 2G wireless communication network, such as a GSM network and a CDMA network, in a wireless Internet network, such as a Wi-Fi network, in a mobile internet network, such as a WiBro network and a WiMax network, or in a wireless communication network supporting packing transmission. The first communication part 130 may include functions/features of a communication part of a mobile communication device used in such a wireless communication network.

The first input part 140 receives input information according to user manipulation. Examples of the input information include mode selection information for mode switching, root canal working length information that is manually input by the user, and identification information that is manually input by the user. In addition, examples of the input information further include various pieces of command information for determination and processing of a root canal working length, such as transmission command information for transmitting the identified root canal working length information to the server 300, storage command information for storing the identified root canal working length information in the storage 120, reception command information for receiving the identified root canal working length information from the server 300, loading command information for loading the identified root canal working length information stored in the storage 120, and move command information for moving the root canal working length information and the identification information received through the first communication part 130 to an appropriate menu or area on an interface screen of the first display 150, which will be described later. Examples of the first input part 140 may include input devices such as a keyboard, a keypad, a touchpad, and a mouse, or a graphic user interface controllable by the input devices.

The first display 150 displays various pieces of information used or intermediately or finally generated in the dental apparatus 100, on the interface screen. Examples of the first display 150 may include various visual display means, such as a liquid-crystal display (LCD), light-emitting diodes (LEDs), organic light-emitting diodes (OLEDs), and a cathode-ray tube (CRT).

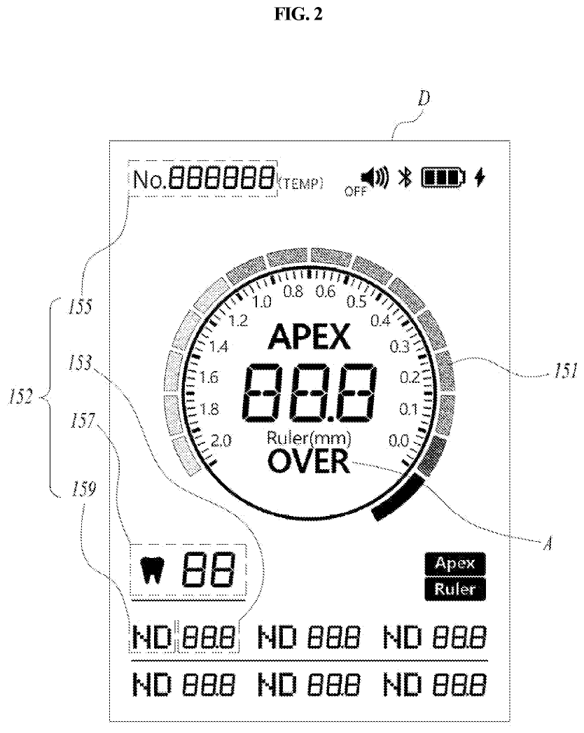

FIG. 2 is a view illustrating an example of an interface screen D that the first display 150 displays.

The first display provides a first menu 151 and a second menu 152 through the interface screen D.

The first menu 151 displays the distance between the file and the apical foramen and the distance is calculated by the first controller in the first mode. The first menu 151 may display distance information between the file and the apical foramen in real time from when the distance between the file and the apical foramen is equal to or lower than a predetermined upper limit value (for example, 2.0 mm) to when the distance is equal to or higher than a predetermined lower limit value (0.0 mm). The first menu 151 may display the distance between the file and the apical foramen in numerals and/or predetermined graphics. The first menu 151 may display a warning message to the user when the distance between the file and the apical foramen reaches a predetermined reference value between the upper limit value and the lower limit value.

The user inserts the file into the tooth in the first mode, observing the distance between the file and the apical foramen displayed in the first menu 151. When the distance between the file and the apical foramen reaches the predetermined reference value, the user stops inserting the file. The upper limit value, the lower limit value, and the reference value may be adjusted according to the input information through the first input part.

The second menu 152 displays the root canal working length information and the identification information in the second mode. The identification information may include at least one selected from a group of subject identification information for identifying a subject, tooth identification information for identifying a tooth, and root canal working length identification information for identifying a root canal working length. The second menu 152 may provide a first area 153 for displaying the root canal working length information, and may provide at least one selected from a group of a second to a fourth area 155, 157, and 159 for displaying at least one selected from a group of the subject identification information, the tooth identification information, and the root canal working length identification information.

The first area 153 displays the root canal working length information. The root canal working length information may be transmitted from the file length measurement device or manually input by the user through the first input part. The root canal working length information may be in numerals, for example. The second area 155 displays the subject identification information that is identification information of a particular subject distinguished from other subjects. The subject identification information may be transmitted from the server or manually input by the user through the first input part. The subject identification information may be in numerals, for example.

The third area 157 displays the tooth identification information that is identification information of a particular tooth distinguished from other teeth. The tooth identification information may be transmitted from the server or manually input by the user through the first input part. The tooth identification information may be in numerals or a combination of numerals and alphabet letters, for example.

The fourth area 159 displays the root canal working length identification information that is identification information of a particular root canal distinguished from other root canals in the tooth. The root canal working length identification information may be transmitted from the server or manually input by the user through the first input part. For example, the root canal working length identification information may be in alphabet letters and/or numerals.

In a single tooth, a plurality of root canals may exist. Therefore, a plurality of the first areas 153 for displaying the root canal working length information and a plurality of the fourth areas 159 for displaying the root canal working length identification information may form a plurality of one-to-one matched pairs, and there may be a maximum of six pairs.

In addition, the first display 150 may display various pieces of information, which include the currently executed mode, required for driving the dental apparatus, through the interface screen D.

Referring back to FIG. 1, the first controller 160 performs switching between the first mode for determining the root canal working length and the second mode for processing the root canal working length, according to the user's selection. In each mode, the first controller 160 performs various control operations for determination of the root canal working length and for processing of the root canal working length.

For example, in terms of hardware, the first controller 160 may be realized using at least one selected from a group of application specific integrated circuits (ASICs), digital signal processors (DSPs), digital signal processing devices (DSPDs), programmable logic devices (PLDs), field-programmable gate arrays (FPGAs), processors, controllers, micro-controllers, and microprocessors. In addition, the first controller 160 may be realized as a firmware/software module executable on a hardware platform. In this case, the firmware/software module may be realized by one or more software applications written in an appropriate program language.

Hereinafter, specific control operations of the first controller 160 will be described distinguishing the first and the second mode. FIG. 2 is also referenced.

(1) First Mode

The first mode is for determining the root canal working length. The first controller 160 executes the first mode according to the mode selection information input to the first input part 140.

In the first mode, the user makes the file 90 penetrate a stopper 91 made of a soft material, such as rubber, connects the file 90 to the holder 13, hooks the probe 11 onto the user's lip to enable the probe 11 to touch the oral mucosa, and inserts the file 90 through the hole formed in the tooth during the pulp chamber opening, starting from the end of the file 90. In this process, the stopper 91 is caught on the cusp tip of the tooth and only the file 90 is inserted into the tooth. In the first mode, the signal detector 110 applies a predetermined electrical signal to the file 90 through the holder 13, and detects an electrical signal, such as a resistance value or an impedance value, varying according to the distance between the end of the file 90 and the apical foramen, through the probe 11.

In the first mode, the first controller 160 detects a change in the electrical signal detected through the signal detector 110, uses the change to calculate the distance between the file 90 and the apical foramen in real time, and displays the distance on the first menu 151 of the first display 150. When the distance between the file 90 and the apical foramen reaches a predetermined reference value, the first controller 160 may generate a warning sound or display a warning message through the interface screen D of the first display 150. To this end, the dental apparatus 100 may further include an output means, such as a speaker, and in the interface screen D of the first display 150, the first menu 151 may further include an alarm area A for displaying a warning message, for example. For example, when the distance between the file 90 and the apical foramen reaches a reference value, the first controller 160 give an alarm through the speaker or displays a predetermined warning message in the alarm area A. Then, the user who recognizes the alarm or the warning message stops inserting the file 90 into the tooth and removes the file 90 from the tooth.

(2) Second Mode

The second mode is for processing the root canal working length. The first controller 160 executes the second mode according to the mode selection information input to the first input part 140.

In the second mode, the first controller 160 receives the identification information transmitted from the server 300 through the first communication part 130 or manually input by the user through the first input part 140, stores the identification information in the storage 120, and displays the identification information in at least one selected from the group of the second to the fourth area 155, 157, and 159 of the second menu 152 of the first display 150. The identification information may be at least one selected from the group of the subject identification information, the tooth identification information, and the root canal working length identification information. The first controller 160 displays the pieces of identification information in the respective areas. For example, when the user manually inputs identification information through the first input part 140, the first controller 160 displays a predetermined initial value in at least one selected from the group of the second to the fourth area 155, 157, and 159 of the second menu 152 of the first display 150 in order, and the user may select the initial value as the identification information through the first input part 140.

In the second mode, the first controller 160 receives the root canal working length information transmitted from the file length measurement device 200 through the first communication part 130 or input by the user through the first input part 140, stores the root canal working length information in the storage 120, and displays the root canal working length information in the first area 153 of the second menu 152 of the first display 150. For example, the user may move the root canal working length information appropriately within a plurality of the first area 153 through the first input part 140 for matching with the corresponding root canal working length identification information.

In the second mode, according to the transmission command information or the storage command information input through the first input part 140, the first controller 160 generates the identified root canal working length information by using the identification information and the root canal working length information and stores the identified root canal working length information in the storage 120 or transmits the same to the server 300. The identified root canal working length information may be in the form of a hierarchical combination or mix of at least one piece of identification information and the root canal working length information.

In the second mode, the user may recognize the identification information and the root canal working length information, which are separate individual pieces of information, in a determined area of a single interface screen D. The identification information and the root canal working length information may be combined or mixed to generate the identified root canal working length information that is integrated information, and the identified root canal working length information may be stored in the storage 120 or transmitted to the server 300.

In addition, in the second mode, the first controller 160 may receive the identified root canal working length information from the server 300 according to the reception command information input to the first input part 140, or may load the identified root canal working length information stored in the storage 120 according to the loading command information input to the first input part 140. The first controller 160 displays the identification information and the root canal working length information on the first display 150 using the identified root canal working length information received from the server 300 or loaded from the storage 120.

Therefore, the user may perform root canal treatment by referring to the identification information and the root canal working length information displayed on the first display 150 at any time during the root canal treatment after measurement of the root canal working length.

The dental apparatus 100 according to the present disclosure calculates and displays the distance between the file 90 inserted into the tooth and the apical foramen in the first mode. In the second mode, the dental apparatus 100 generates the identified root canal working length information by using the root canal working length information and the identification information, and stores or transmits the identified root canal working length information to the outside, and displays the root canal working length information and the identification information by using the identified root canal working length information transmitted from the outside. Through the dental apparatus 100 according to the present disclosure, the root canal working length information and the identification information that are separate individual pieces of information may be integrated as the identified root canal working length information, and the identified root canal working length information may be stored and processed.

Therefore, errors in matching the tooth with the root canal working length or in recording the root canal working length can be reduced, and the root canal working length information and the identification information can be recognized and utilized anytime with the identified root canal working length information.

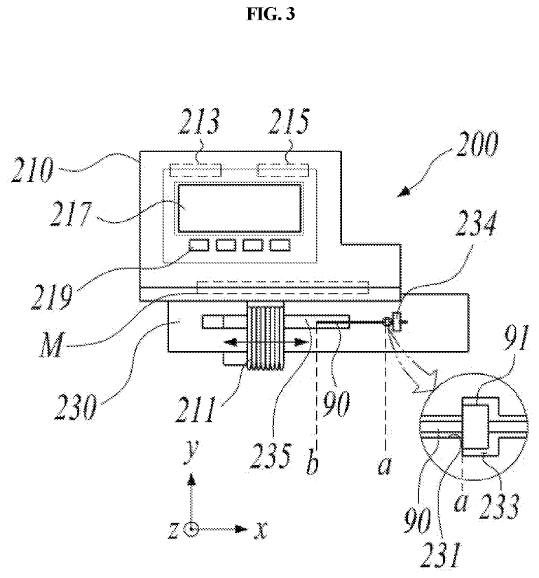

Hereinafter, the file length measurement device 200 will be described with reference to FIGS. 3 to 6.

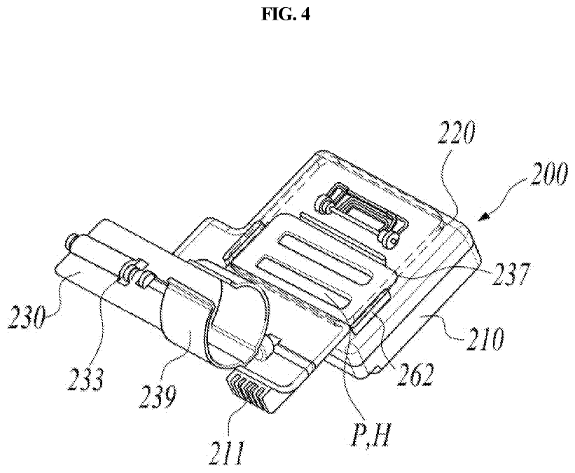

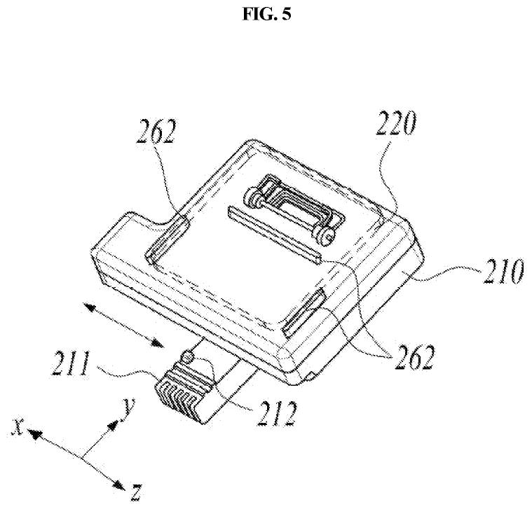

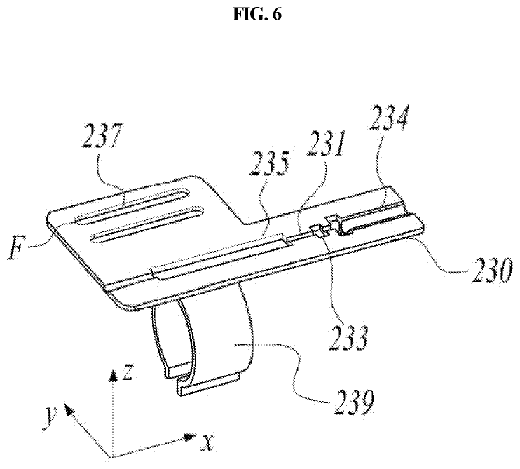

FIG. 3 is a front view of the file length measurement device 200. FIG. 4 is a rear perspective view of the file length measurement device 200. FIG. 5 is a rear perspective view of a part of a body 210 of the file length measurement device. FIG. 6 is a front perspective view of a file support 230 of the file length measurement device 200.

The file length measurement device 200 includes the file support 230 and the body 210. The file support 230 on which the file 90 is placed provides a reference point at which a first location a of the file 90 is align. The body 210 is detachably coupled to the file support 230, calculates and displays the distance between the reference point and a second location b that is a point of the file 90 placed on the file support 230, and transmits the measurement value of the distance to the dental apparatus 100 at the outside according to the user's selection.

Each element will be described in detail.

The file support 230 is a part on which the file 90 is placed, is detachably coupled to the body 210, and provides the reference point at which the first location a of the file 90 is aligned when the file is placed.

In the upper surface of the file support 230, a support groove 231 in which the file 90 is placed may be provided. For example, the support groove 231 may be in the shape of a trench that is recessed to a predetermined depth from the upper surface of the file support 230 and is disposed in a length direction of the file 90. At a first side of the support groove 231, an insertion hole 233 into which the stopper 91 penetrated by the file 90 is inserted may be provided. For example, the insertion hole 233 may be in the shape of a hole penetrating the file support 230 and having a greater width than the support groove 231. In this case, a side of the insertion hole 233 toward the end of the file 90 is the reference point. With respect to the insertion hole 233, the first side of the support groove 231 corresponding to the head portion of the file 90 may be provided with an extension groove 234 in which the head portion of the file 90 is placed. For example, the extension groove 234 may be in the shape of a trench that has a greater width than the support groove 231. With respect to the insertion hole 233, a second side of the support groove 231 corresponding to the wire portion of the file 90 may be provided with a guide groove 235 for guiding the movement of a location marker 211 of the body 210, which will be described later. For example, the guide groove 235 may be in the shape of a slit that penetrates at least a portion of the second side of the support groove 231 and has a greater width than the support groove 231.

In addition, a side of the file support 230 may be provided with a fastening end 237 that is detachably coupled to the body 210, which will be described later. For example, the fastening end 237 is in the shape in which the side of the file support 230 extends in a planar manner. In addition, the rear surface of the file support 230 may be provided with a clip 239 into which the user puts and fixes his or her finger.

The body 210 has a hexahedron or similar shape. A side of the body 210 toward the file support 230 is provided with a location marker 211 that moves in the length direction of the file 90 placed on the file support 230. Inside the body 210, a length measurement part M, a second communication part 213, and a second controller 215 are provided. At another side of the body 210, that is the front surface, a second display 217 and a second input part 219 are provided.

When the file support 230 and the body 210 are coupled to each other, the location marker 211 is located at the top of the file 90 placed on the file support 230, and moves in the length direction of the file 90 along a side face of the body 210 according to user manipulation. The location marker 211 may be provided with a mark line at an end of a side toward the head portion of the file 90. For example, the location marker 211 penetrates the side face of the body 210 such that a first end of the location marker 211 is embedded in the body 210 and a second end of the location marker 211 is exposed to the outside of the body 210. For example, the second end of the location marker 211 is provided with a guide protrusion 212 that is inserted into the guide groove 235 of the file support 230 and moves to stably guide the movement in the length direction of the file 90.

The length measurement part M generates an electrical signal according to the movement distance of the location marker 211 in the body 210.

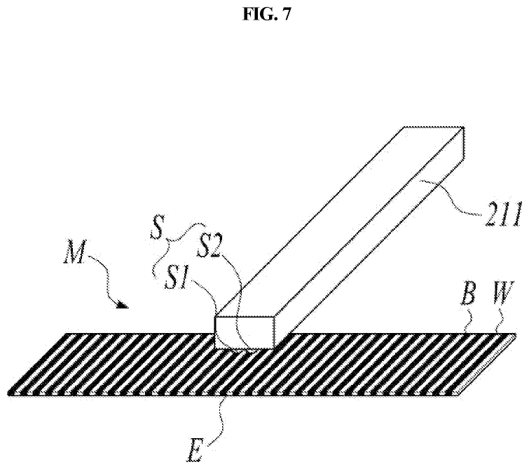

FIG. 7 is a view briefly illustrating the length measurement part of the file length measurement device according to the present disclosure.

For example, the length measurement part M may include a photo reflector sensor S and an encoder strip E. The photo reflector sensor S is connected to the first end of the location marker 211 in the body 210. The encoder strip E is disposed in the movement direction of the location marker 211 in the body 210.

The encoder strip E may provide a pattern of black B and white W repeating in the length direction. The photo reflector sensor S may include a light-emitting element S1 and a light-receiving element S2. The light-emitting element S1 emits light toward the encoder strip E. The light-receiving element S2 receives light that passes through the encoder strip E or reflects off the encoder strip E, and generates an electrical signal proportional to the quantity of the received light. As the location marker 211 moves, the photo reflector sensor S moves in the length direction of the encoder strip E. The light-receiving element S2 generates an electrical signal of which the intensity is periodically changed by the black B and white W pattern of the encoder strip E.

FIGS. 3 to 6 are referenced again.

For example, the fastening end 237 of the file support 230 comes into close contact with the rear surface of the body 210, and the rear surface of the body 210 may be provided with tongs 220 that press the fastening end 237 of the file support 230.

The second controller 215 calculates, on the basis of the electrical signal generated by the length measurement part M, the distance between the reference point of the file support 230 at which the first location a of the file 90 is aligned and the second location b of the file 90 indicated by the mark line of the location marker 211, and displays the distance on the second display 217. According to input information input to the second input part 219, the second controller 215 converts the value of the distance into digital data and transmits the digital data to the dental apparatus 100 through the second communication part 213.

Examples of hardware and/or software configurations of the second controller 215, the second display 217, the second input part 219, and the second communication part 213 may be substantially the same as or similar to the first controller 160, the first display 150, the first input part 140, and the first communication part 130 described above, and thus a redundant description thereof will be omitted.

The user opens the tongs 220 of the body 210, makes the fastening end 237 of the file support 230 come into close contact with the rear surface of the body 210, closes the tongs 220 to couple the body 210 with the file support 230, and puts his or her finger into the clip 239 to grip the file length measurement device 200 stably.

Next, the user holds the head portion of the file 90 with the other hand, and inserts the stopper 91 into the insertion hole 233 to place the file 90 in the support groove 231. As a result, the stopper 91 penetrates and is inserted into the insertion hole 233, and the end of the stopper 91 toward the end of the file 90 as the first location a of the file 90 is aligned at a side of the insertion hole 233 toward the end of the file 90 as the reference point of the file support 230.

Next, the user moves the location marker 211 to align the mark line of the location marker 211 at the end of the file 90 as the second location b of the file 90. Then, the length measurement part M generates an electrical signal according to the movement distance of the location marker 211. The second controller 215 calculates, on the basis of the electrical signal generated by the length measurement part M, the distance between the reference point of the file support 230 and the mark line of the location marker 211, and displays the distance on the second display 217. The distance between the reference point and the mark line corresponds to the distance between the end of the stopper 91 toward the end of the file 90 and the end of the file 90. The distance eventually corresponds to the root canal working length information, that is, an in-tooth insertion distance of the file 90.

Next, the user recognizes the root canal working length information displayed on the second display 217, and inputs a transmission command through the second input part 219.

Accordingly, the second controller 215 converts the distance between the reference point of the file support 230 and the mark line of the location marker 211 into a digital value, and transmits the digital value as the root canal working length information to the dental apparatus through the second communication part 213.

The file length measurement device 200 is capable of actually measuring the in-tooth insertion length of the file 90 as well as transmitting the measured distance value as the root canal working length information to the dental apparatus 100 at the outside. Accordingly, errors or mistakes that may occur in a process of manually recording root canal working length information in the related art can be minimized.

In the meantime, the file support 230 on which the file 90 is placed may be smeared with blood or contaminants because of the file 90 inserted into the tooth, so the file support 230 needs to be cleaned, disinfected, and replaced separately from the body 210. Therefore, in the file length measurement device 200, the file support 230 and the body 210 are detachably coupled to each other.

However, when the file support 230 is detached, a change in the location of the insertion hole 233 changes the reference point. Therefore, the file length measurement device 200 provides a predetermined alignment structure that enables the body 210 and the file support 230 to be coupled to each other in position at all times despite the detachment of the body 210 and the file support 230.

For example, the alignment structure may include: at least one alignment protrusion 262 that is provided at the rear surface of the body 210 and guides at least one edge of the fastening end 237 of the file support 230; and a plurality of fitting holes Hs and a plurality of fitting protrusions Fs provided respectively at the fastening end 237 of the file support 230 and the tongs of the body 210 pressing the fastening end 237, wherein the fitting holes Hs and the fitting protrusions Fs are engaged with each other. Accordingly, the user puts the fastening end 237 of the file support 230 between the alignment protrusions 262 at the rear surface of the body 210 to fix a planar location, that is, a relative location on the X-Y axis plane of FIG. 6, of the file support 230 for the body 210. The user makes the tongs 220 hold the fastening end 237 therebetween such that the fitting holes Hs and the fitting protrusions Fs are engaged with each other, to fix a vertical location, that is, a relative location on the Z axis of FIG. 6, of the file support 230 for the body 210.

In the meantime, the embodiments of the present disclosure are not only realized through the above-described apparatus and/or method. The embodiments of the present disclosure may be realized through a program performing functions that correspond to the configuration of the embodiments of the present disclosure, or through a recording medium on which the program is recorded. Such realization can be easily derived from the description of the above-described embodiments by a person skilled in the art to which the present disclosure pertains.

Although the embodiments of the present disclosure have been described for illustrative purposes, those skilled in the art will appreciate that various modifications, additions and substitutions are possible, without departing from the scope and spirit of the disclosure as disclosed in the accompanying claims.

What is claimed is:

1. A dental apparatus for determination and processing of a root canal working length that is a working distance for root canal treatment, the dental apparatus comprising:
a signal detector configured to detect an electrical signal varying according to a distance between a file inserted into a tooth and an apical foramen;
a display configured to provide a screen;
a communication part configured to communicate with an external device;
an input part configured to receive an input signal caused by user manipulation;
a controller configured to execute a first mode for calculating the distance between the apical foramen and the file by using the electrical signal and for displaying the distance on the screen, and configured to execute a second mode for displaying root canal working length information and identification information received through the communication part or the input part, on the screen, for generating identified root canal working length information by using the root canal working length information and the identification information, and for transmitting the identified root canal working length information to the external device through the communication part according to the input signal; and
a storage configured to store therein the root canal working length information, the identification information, and the identified root canal working length information.

2. The dental apparatus of claim 1, wherein a plurality of the external devices include a first and a second device,
the root canal working length information is received from the first device through the communication part,
the identification information is received from the second device through the communication part, and
the identified root canal working length information is transmitted to the second device through the communication part.

3. The dental apparatus of claim 2, wherein the first device is a file length measurement device configured to measure an in-tooth insertion length of the file and transmit the in-tooth insertion length of the file to the communication part as the root canal working length information, and
the second device is a server configured to store therein an electronic medical record including the identification information.

4. The dental apparatus of claim 1, wherein the identification information includes at least one selected from a group of subject identification information, tooth identification information, and root canal working length identification information.

5. The dental apparatus of claim 1, wherein the signal detector comprises:
a holder configured to have the file connected thereto; and
a probe configured to be connected to a subject's lip, and the signal detector is configured to detect a change in an impedance or resistance value varying according to the distance between the apical foramen and the file.

6. The dental apparatus of claim 1, wherein the controller is configured to display a warning message on the screen when the distance between the file and the apical foramen is equal to or lower than a preset reference value in the first mode.

7. The dental apparatus of claim 1, further comprising a speaker configured to generate a warning sound,
wherein the controller is configured to emit the warning sound through the speaker when the distance between the file and the apical foramen is equal to or lower than a preset reference value.

8. The dental apparatus of claim 1, wherein the controller is configured to display the root canal working length information and the identification information on the screen by using the identified root canal working length information received from the external device to the communication part in the second mode.

9. A dental system using the dental apparatus of claim 1, the dental system comprising:
the dental apparatus;
a file length measurement device configured to measure an in-tooth insertion length of the file and transmit a measurement value of the in-tooth insertion length to the communication part as the root canal working length information; and
a server configured to receive the identified root canal working length information from the communication part and store therein the identified root canal working length information.

10. The dental system of claim 9, wherein the server is configured to transmit the identified root canal working length information pre-stored therein, to the communication part, and
the controller is configured to display the root canal working length information and the identification information on the screen by using the identified root canal working length information received from the server to the communication part in the second mode.
